(19) United States
(12) Patent Application Publication
(10) Pub. No.: US 2013/0256994 A1
(43) Pub. Date: Oct. 3, 2013

(54) SEALING UNIT WITH CONTROLLED FLOW

(71) Applicant: SCHAEFFLER TECHNOLOGIES AG & CO. KG, Herzogenaurach (DE)

(72) Inventors: Seth Claus, Charlotte, NC (US); Jordan Miles, Asheville, NC (US); Charles Schwab, Fort Mill, SC (US)

(73) Assignee: SCHAEFFLER TECHNOLOGIES AG & CO. KG, Herzogenaurach (DE)

(21) Appl. No.: 13/847,503

(22) Filed: Mar. 20, 2013

Related U.S. Application Data
(60) Provisional application No. 61/619,152, filed on Apr. 2, 2012.

(51) Int. Cl. F16J 15/16

(52) U.S. Cl. CPC F16J 15/162
USPC 277/549

(57) ABSTRACT

A shaft seal includes a body portion and a radially protruding lip portion. The body portion has a radial wall with at least one radial groove. The lip portion is integrally formed with the body portion and deflectable for sealing engagement with a shaft. In an example embodiment, the seal is a single piece manufactured by injection molding. In an example embodiment, the seal includes nylon or carbon filled polyamide 46.

### FIELD

The invention relates generally to a fluid seal, and more specifically to a fluid seal with controlled flow for lubrication, for example.

### BACKGROUND

Known seals include steel restrictor rings or piston rings. Also, three-piece seals including an elastomeric core, steel insert, and a bonded polytetrafluoroethylene (PTFE) lip for wear resistance are known. One example is shown in commonly-assigned U.S. patent application Ser. No. 13/298,710.

### BRIEF SUMMARY

Example aspects broadly comprise a shaft seal including a body portion and a radially protruding lip portion. The body portion has a radial wall with at least one groove. In an example embodiment, the groove is a radial groove. The lip portion is integrally formed with the body portion and deflectable for sealing engagement with a shaft. In an example embodiment, the seal is a single piece manufactured by injection molding. In an example embodiment, the seal includes nylon or carbon filled polyamide 46.

In an example embodiment, the lip portion extends axially towards or axially away from the radial wall. In an example embodiment, the at least one radial groove includes a plurality of radial grooves selected to control a lubrication flow. In an example embodiment, the lip portion includes first and second conical surfaces with an intersecting edge arranged for sealing engagement with the shaft. In an example embodiment, the shaft seal includes a circumferential pocket extending axially into the body portion and radially separating respective distal ends of the body portion and the lip portion. Other example aspects broadly comprise a bearing including the shaft seal.

Other example aspects broadly comprise a shaft seal assembly including a housing, a shaft seal, and a cylindrical flow area. The housing has a first radial wall and a first circumferential wall. The shaft seal has a second radial wall in partial sealing engagement with the first radial wall and a second circumferential wall. The flow area is disposed radially between the first and second circumferential walls. In an example embodiment, the second radial wall includes a groove. In an example embodiment, the groove is a radial groove. In an example embodiment, the housing includes a bearing race.

In some example embodiments, the shaft seal assembly includes a shaft and the shaft seal has a deflectable protrusion in compressive engagement with the shaft. In an example embodiment, the shaft seal is rotationally fixed to the shaft by the compressive engagement. In an example embodiment, the shaft seal is a single piece manufactured by injection molding. In an example embodiment, the shaft seal includes nylon or carbon filled polyamide 46.

### BRIEF DESCRIPTION OF THE DRAWINGS

The nature and mode of operation of the present invention will now be more fully described in the following detailed description taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a partial top half section view of a sealing unit with controlled flow shown installed in a bearing according to an example aspect;

FIG. 3 is a partial top half section view of a sealing unit with controlled flow shown installed in a bearing according to an example aspect;

FIG. 4 is a partial perspective view of a radial wall of the sealing unit of FIG. 2 showing a groove; and,

FIG. 5 is a partial top half section view of a sealing unit with controlled flow shown installed in a transmission housing.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

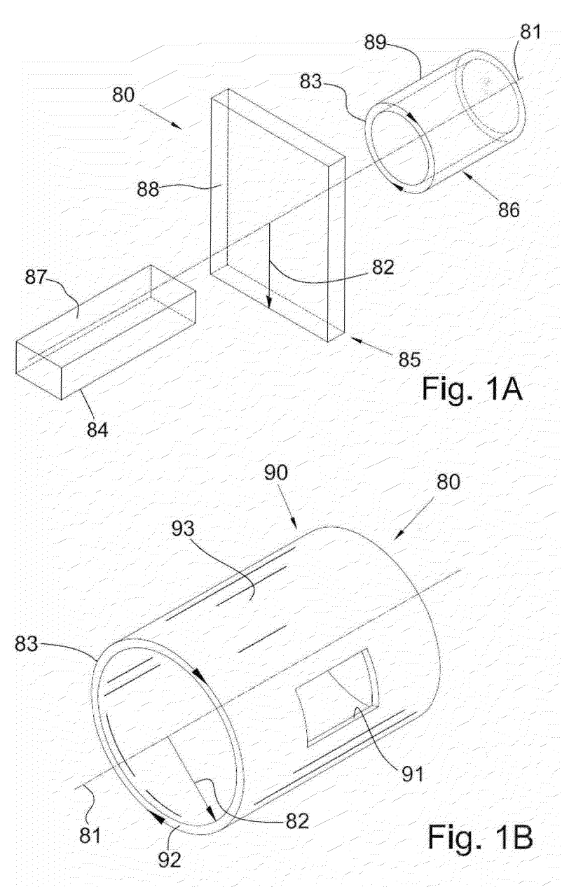

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

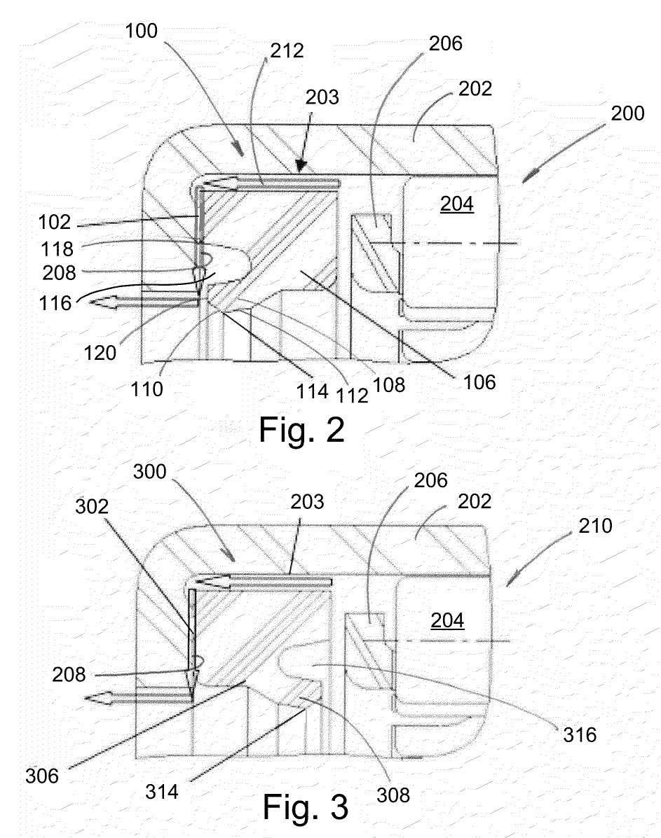

The following description is made with reference to FIG. 2. FIG. 2 is a partial top half section view of sealing unit 100 with controlled flow shown installed in bearing 200 according to an example aspect. Bearing 200 includes race 202, rollers 204, and cage 206. Flow gap 203 is radially disposed between race 202 and sealing unit 100. Race 202 includes radial wall 208 aligned with radial wall 102 of sealing unit 100 as described below. Although bearing 200 is shown as a roller bearing, other applications may exist and should be considered within the scope of the invention. For example, bearing 200 may be a radial bearing or an axial bearing. Example bearings may include a ball bearing, needle bearing, tapered roller bearing, or spherical roller bearing.

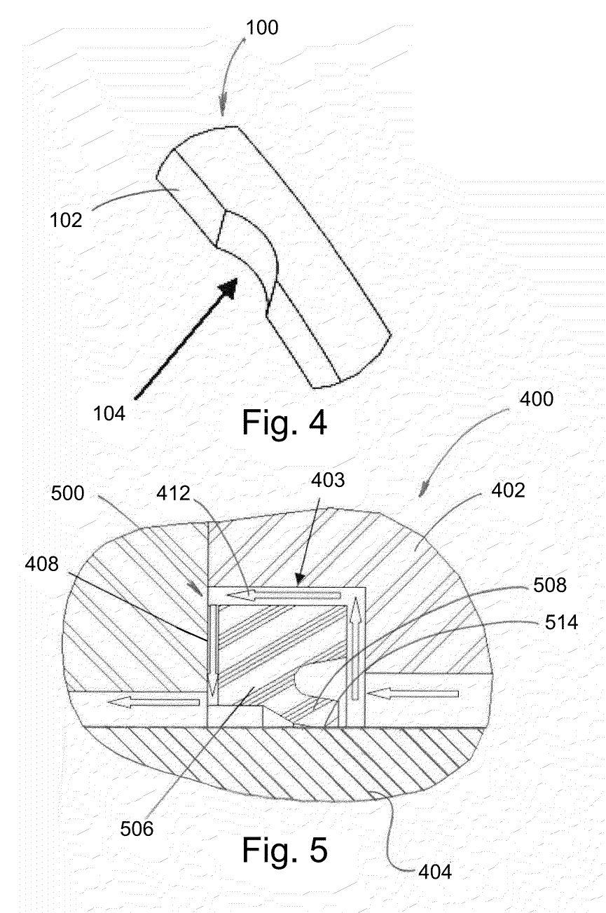

The following description is made with reference to FIGS. 2-4. FIG. 3 is a top half section view of sealing unit 300 with controlled flow shown installed in bearing 210 according to an example aspect. FIG. 4 is a partial perspective view of radial wall 102 of sealing unit 100 of FIG. 2 showing groove 104. Sealing unit, or shaft seal, 100 includes body portion 106 with radial wall 102. Wall 102 includes radial groove 104. In an example embodiment, seal 100 may include a plurality of radial grooves selected to control a lubrication flow as described below. Seal 100 also includes radially protruding lip portion 108. Although only one lip portion is shown, other embodiments (not shown) may include multiple lip portions 108. By radially protruding, we mean that lip portion 108 extends at least partially radially inwards or outwards from body portion 106. Although lip portion 108 extends radially inward in FIG. 2, other embodiments (not shown) include a radially outwardly protruding lip portion.

Lip portion 108 is integrally formed with body portion 106. That is, lip portion 108 and body portion 106 are formed from a same piece of material. Lip portion 108 extends axially towards radial wall 102 in the embodiment shown in FIG. 2, and lip 308 extends axially away from radial wall 302 in FIG. 3. Lip portion 108 includes respective conical surfaces 110 and 112 with intersecting circumferential edge 114. Circumferential pocket 116 extends axially into body portion 106 and radially separates body portion distal end 118 and lip portion distal end 120. Furthermore, as shown in the embodiment of FIG. 3, high pressure to the right of seal 300 acting in pocket 316 tries to expand the pocket and urges lip portion 308 into tighter engagement with a shaft (not shown), locking the lip to the shaft.

In an example embodiment, seal 100 is manufactured from injection molded nylon or any suitable material known in the art. For example, any reasonably rigid or stiff polymer may be used. In an example embodiment, seal 100 comprises carbon filled polyamide 46. Portion 108 is deflectable for sealing engagement with a shaft (for example shaft 404 in FIG. 5) at edge 114 as described below. Therefore, with the exception of groove 104, seal 100 seals the shaft to radial wall 208 of race 202. Controlled fluid flow follows a path indicated by arrows 212 that proceeds through flow gap 203 and groove 104, and exits between the shaft and race 202. Groove 104 is designed to control flow through bearing 200 to prevent lubricant stagnation within the bearing or cavity, improve lubrication, and prevent overheating. The lubricant may be automatic transmission fluid (ATF), for example.

Portion 108 tightly grips the shaft so that seal 100 rotates with the shaft and rotates with a differential speed relative to outer race 202. That is, portion 108 has an interference fit with the shaft. During assembly, portion 108 is flexed by the shaft so that the shaft may slide through. This configuration ensures that edge 114 is not worn from rotating contact with the shaft, and the sliding surface between the seal and the race is lubricated by flow through the groove to reduce friction and component wear. This ensures that the groove depth remains the same and flow through the seal will remain consistent throughout its life.

The following description is made with reference to FIG. 5. FIG. 5 is a partial top half section view of sealing unit 500 with controlled flow shown installed in transmission 400. Transmission 400 may be a multi-speed planetary automatic vehicle transmission, for example. The transmission includes housing 402 sealed to unit 500 at radial wall 408, and shaft 404 sealed to unit unit 500 at edge 514 of deflectable portion 508. Flow through transmission 400 (indicated by arrows 412) between housing 402 and shaft 404 is restricted by a groove of seal 500 similar to groove 104 described above.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A shaft seal comprising:
a body portion including a radial wall with at least one groove; and,
a radially protruding lip portion, integrally formed with the body portion, and deflectable for sealing engagement with a shaft.

2. The shaft seal of claim 1 wherein the groove is a radial groove.

3. The shaft seal of claim 1 wherein the seal is a single piece manufactured by injection molding and comprises nylon or carbon filled polyamide 46.

4. The shaft seal of claim 1 wherein the lip portion extends axially towards or axially away from the radial wall.

5. The shaft seal of claim 1 wherein the at least one radial groove comprises a plurality of radial grooves selected to control a lubrication flow.

6. The shaft seal of claim 1 wherein the lip portion includes first and second conical surfaces with an intersecting edge arranged for sealing engagement with the shaft.

7. The shaft seal of claim 1 further comprising a circumferential pocket extending axially into the body portion and radially separating respective distal ends of the body portion and the lip portion.

8. A bearing comprising the shaft seal of claim 1.

9. A shaft seal assembly comprising:
a housing with a first radial wall and a first circumferential wall;
a shaft seal including a second radial wall in partial sealing engagement with the first radial wall and a second circumferential wall; and,
a cylindrical flow area disposed radially between the first and second circumferential walls.

10. The shaft seal of claim 9 wherein the second radial wall comprises a groove.

11. The shaft seal of claim 10 wherein the groove is a radial groove.

12. The shaft seal assembly of claim 9 wherein the housing comprises a bearing race.

13. The shaft seal assembly of claim 9 further comprising a shaft, wherein the shaft seal comprises a deflectable protrusion in compressive engagement with the shaft.

14. The shaft seal assembly of claim 13 wherein the shaft seal is rotationally fixed to the shaft by the compressive engagement.

15. The shaft seal assembly of claim 9 wherein the shaft seal is a single piece manufactured by injection molding and comprises nylon or carbon filled polyamide 46.
